(19) United States
(12) Patent Application Publication
(10) Pub. No.: US 2010/0039424 A1
(43) Pub. Date: Feb. 18, 2010

(54) METHOD OF REDUCING OFFSET VOLTAGE IN A MICROELECTROMECHANICAL DEVICE

(75) Inventors: Feng Ming Pao, Yung-Ho City (TW); Chung-Hsien Lin, Hsinchu City (TW); Mao-Chuan Ke, Sioushuei Township (TW)

Correspondence Address: KNOBBE, MARTENS, OLSON & BEAR, LLP, 2040 MAIN STREET, FOURTEENTH FLOOR, IRVINE, CA, 92614, US

(73) Assignee: QUALCOMM MEMS Technologies, Inc., San Diego, CA (US)

(21) Appl. No.: 12/191,869

(22) Filed: Aug. 14, 2008

(51) Int. Cl. G02B 27/00

(52) U.S. Cl. 345/214; 359/578

(57) ABSTRACT

A method of conditioning a microelectromechanical device is disclosed. In one embodiment the method comprises applying a conditioning signal to a microelectromechanical device having an offset voltage of a first sign, the conditioning signal having an average that is of a second sign which is opposite the first sign. In another embodiment the method comprises applying a conditioning signal to a microelectromechanical device having an offset voltage of a first value, the conditioning signal having an average of a second value which differs from the first value.

### BACKGROUND

1. Field of the Invention

This invention relates to microelectromechanical systems for use as interferometric modulators. More particularly, this invention relates to systems and methods for improving the micro-electromechanical operation of interferometric modulators.

2. Description of the Related Technology

Microelectromechanical systems (MEMS) include micro mechanical elements, actuators, and electronics. Micromechanical elements may be created using deposition, etching, and or other micromachining processes that etch away parts of substrates and/or deposited material layers or that add layers to form electrical and electromechanical devices. One type of MEMS device is called an interferometric modulator. As used herein, the term interferometric modulator or interferometric light modulator refers to a device that selectively absorbs and/or reflects light using the principles of optical interference. In certain embodiments, an interferometric modulator may comprise a pair of conductive plates, one or both of which may be transparent and/or reflective in whole or part and capable of relative motion upon application of an appropriate electrical signal. In a particular embodiment, one plate may comprise a stationary layer deposited on a substrate and the other plate may comprise a metallic membrane separated from the stationary layer by an air gap. As described herein in more detail, the position of one plate in relation to another can change the optical interference of light incident on the interferometric modulator. Such devices have a wide range of applications, and it would be beneficial in the art to utilize and/or modify the characteristics of these types of devices so that their features can be exploited in improving existing products and creating new products that have not yet been developed.

### SUMMARY

The system, method, and devices of the invention each have several aspects, no single one of which is solely responsible for its desirable attributes. Without limiting the scope of this invention, its more prominent features will now be discussed briefly. After considering this discussion, and particularly after reading the section entitled “Detailed Description of Certain Embodiments” one will understand how the features of this invention provide advantages over other display devices.

One aspect of the invention is a method of conditioning a microelectromechanical device, the method comprising applying a conditioning signal to a microelectromechanical device having an offset voltage of a first sign, the conditioning signal having an average that is of a second sign which is opposite the first sign.

Another aspect of the invention is a method of conditioning a microelectromechanical device, the method comprising applying a conditioning signal to a microelectromechanical device having an offset voltage of a first value, the conditioning signal having an average of a second value, wherein the absolute difference between the first value and the second value is greater than 0.1 volts.

Still other aspects of the invention include a microelectromechanical device made by one of the above-described processes. In a particular embodiment, the microelectromechanical device comprises an interferometric modulator. Still another aspect of the invention is a display device comprises an interferometric modulator made by one of the above-described processes.

These and other embodiments are described in greater detail below.

### BRIEF DESCRIPTION OF THE DRAWINGS

FIG. 1 is an isometric view depicting a portion of one embodiment of an interferometric modulator display in which a movable reflective layer of a first interferometric modulator is in a relaxed position and a movable reflective layer of a second interferometric modulator is in an actuated position.

FIG. 2 is a system block diagram illustrating one embodiment of an electronic device incorporating a 3×3 interferometric modulator display.

FIG. 3 is a diagram of movable mirror position versus applied voltage for one exemplary embodiment of an interferometric modulator of FIG. 1.

FIG. 4 is an illustration of a set of row and column voltages that may be used to drive an interferometric modulator display.

FIGS. 5A and 5B illustrate one exemplary timing diagram for row and column signals that may be used to write a frame of display data to the 3×3 interferometric modulator display of FIG. 2.

FIGS. 6A and 6B are system block diagrams illustrating an embodiment of a visual display device comprising a plurality of interferometric modulators.

FIG. 7A is a cross section of the device of FIG. 1.

FIG. 7B is a cross section of an alternative embodiment of an interferometric modulator.

FIG. 7C is a cross section of another alternative embodiment of an interferometric modulator.

FIG. 7D is a cross section of yet another alternative embodiment of an interferometric modulator.

FIG. 7E is a cross section of an additional alternative embodiment of an interferometric modulator.

FIG. 8 shows a diagram of movable mirror position versus applied voltage for an interferometric modulator having an offset voltage of 1.0 volts.

FIG. 9 is a flowchart illustrating a method of conditioning a microelectromechanical device in order to reduce the offset voltage.

FIG. 10A is a graph illustrating an alternating square voltage waveform for conditioning an interferometric modulator array.

FIG. 10B is a graph illustrating a triangular voltage waveform for conditioning an interferometric modulator array.

FIG. 11A is a diagram representing a box plot of the offset voltage of a number of devices before a conditioning process has been performed.

FIG. 11B is a diagram representing a box plot of the offset voltage of a number of devices after a conditioning process has been performed.

FIG. 12 is a diagram representing a box plot of the offset voltage of a number of devices after a conditioning process has been performed with conditioning waveforms having different average values.

### DETAILED DESCRIPTION OF PREFERRED EMBODIMENTS

The following detailed description is directed to certain specific embodiments of the invention. However, the invention can be embodied in a multitude of different ways. In this description, reference is made to the drawings wherein like parts are designated with like numerals throughout. As will be apparent from the following description, the embodiments may be implemented in any device that is configured to display an image, whether in motion (e.g., video) or stationary (e.g., still image), and whether textual or pictorial. More particularly, it is contemplated that the embodiments may be implemented in or associated with a variety of electronic devices such as, but not limited to, mobile telephones, wireless devices, personal data assistants (PDAs), hand-held or portable computers, OPS receivers/navigators, cameras, MP3 players, camcorders, game consoles, wrist watches, clocks, calculators, television monitors, flat panel displays, computer monitors, auto displays (e.g., odometer display, etc.), cockpit controls and/or displays, display of camera views (e.g., display of a rear view camera in a vehicle), electronic photographs, electronic billboards or signs, projectors, architectural structures, packaging, and aesthetic structures (e.g., display of images on a piece of jewelry). MEMS devices of similar structure to those described herein can also be used in non-display applications such as in electronic switching devices.

The inventors have discovered that existing methods of making interferometric modulators are not entirely satisfactory in that the resulting interferometric modulators may have non-zero offset voltages. Relatively complicated drive schemes have been developed to compensate for the effects of the non-zero offset voltages on device performance, but it in some situations it may be desirable to reduce or avoid such complicated drive schemes. An embodiment provides a conditioning process that involves a waveform with a non-zero DC component. The result of conditioning a device using this process is a reduction in the offset voltage, i.e., the offset voltage is shifted closer to zero.

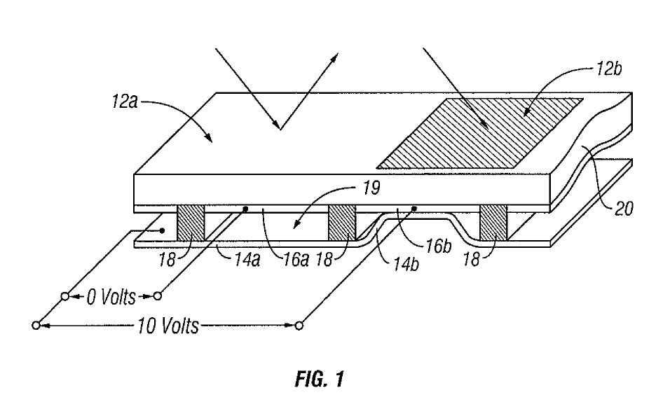

One interferometric modulator display embodiment comprising an interferometric MEMS display element is illustrated in FIG. 1. In these devices, the pixels are in either a bright or dark state. In the bright (“on” or “open”) state, the display element reflects a large portion of incident visible light to a user. When in the dark (“off” or “closed”) state, the display element reflects little incident visible light to the user. Depending on the embodiment, the light reflectance properties of the “on” and “off” states may be reversed. MEMS pixels can be configured to reflect predominantly at selected colors, allowing for a color display in addition to black and white.

FIG. 1 is an isometric view depicting two adjacent pixels in a series of pixels of a visual display, wherein each pixel comprises a MEMS interferometric modulator. In some embodiments, an interferometric modulator display comprises a row/column array of these interferometric modulators. Each interferometric modulator includes a pair of reflective layers positioned at a variable and controllable distance from each other to form a resonant optical cavity with at least one variable dimension. In one embodiment, one of the reflective layers may be moved between two positions. In the first position, referred to herein as the relaxed position, the movable reflective layer is positioned at a relatively large distance from a fixed partially reflective layer. In the second position, referred to herein as the actuated position, the movable reflective layer is positioned more closely adjacent to the partially reflective layer. Incident light that reflects from the two layers interferes constructively or destructively depending on the position of the movable reflective layer, producing either an overall reflective or non-reflective state for each pixel.

The depicted portion of the pixel array in FIG. 1 includes two adjacent interferometric modulators 12a and 12b. In the interferometric modulator 12a on the left, a movable reflective layer 14a is illustrated in a relaxed position at a predetermined distance from an optical stack 16a, which includes a partially reflective layer. In the interferometric modulator 12b on the right, the movable reflective layer 14b is illustrated in an actuated position adjacent to the optical stack 16b.

The optical stacks 16a and 16b (collectively referred to as optical stack 16), as referenced herein, typically comprise of several fused layers, which can include an electrode layer, such as indium tin oxide (ITO), a partially reflective layer, such as chromium, and a transparent dielectric. The optical stack 16 is thus electrically conductive, partially transparent and partially reflective, and may be fabricated, for example, by depositing one or more of the above layers onto a transparent substrate 20. In some embodiments, the layers are patterned into parallel strips, and may form row electrodes in a display device as described further below. The movable reflective layers 14a, 14b may be formed as a series of parallel strips of a deposited metal layer or layers (orthogonal to the row electrodes of 16a, 16b) deposited on top of posts 18 and an intervening sacrificial material deposited between the posts 18. When the sacrificial material is etched away, the movable reflective layers 14a, 14b are separated from the optical stacks 16a, 16b by a defined gap 19. A highly conductive and reflective material such as aluminum may be used for the reflective layers 14, and these strips may form column electrodes in a display device.

With no applied voltage, the cavity 19 remains between the movable reflective layer 14a and optical stack 16a, with the movable reflective layer 14a in a mechanically relaxed state, as illustrated by the pixel 12a in FIG. 1. However, when a potential difference is applied to a selected row and column, the capacitor formed at the intersection of the row and column electrodes at the corresponding pixel becomes charged, and electrostatic forces pull the electrodes together. If the voltage is high enough, the movable reflective layer 14 is deformed and is forced against the optical stack 16. A dielectric layer (not illustrated in this Figure) within the optical stack 16 may prevent shorting and control the separation distance between layers 14 and 16, as illustrated by pixel 12b on the right in FIG. 1. The behavior is the same regardless of the polarity of the applied potential difference. In this way, row/column actuation that can control the reflective vs. non-reflective pixel states is analogous in many ways to that used in conventional LCD and other display technologies.

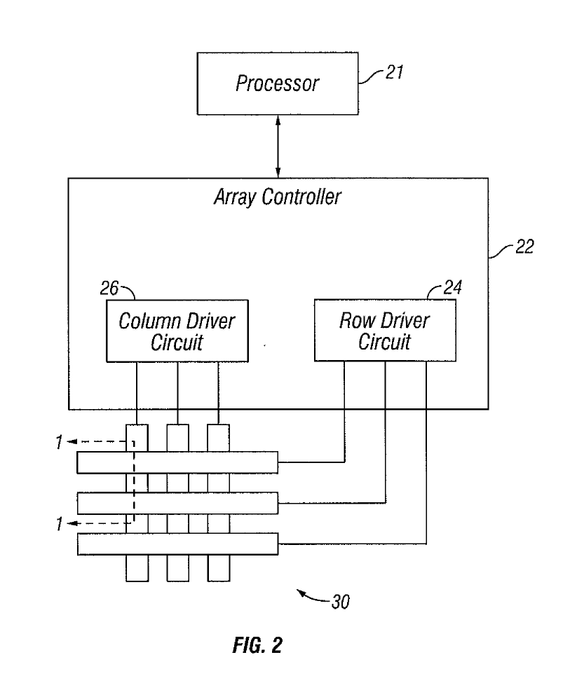

FIGS. 2 through 5 illustrate one exemplary process and system for using an array of interferometric modulators in a display application.

FIG. 2 is a system block diagram illustrating one embodiment of an electronic device that may incorporate aspects of the invention. In the exemplary embodiment, the electronic device includes a processor 21 which may be any general purpose single- or multi-chip microprocessor such as an ARM, Pentium®, Pentium II®, Pentium III®, Pentium IV®, Pentium® Pro, an 8051, a MIPS®, a Power PC®, an ALPHA®, or any special purpose microprocessor such as a digital signal processor, microcontroller, or a programmable gate array. As is conventional in the art, the processor 21 may be configured to execute one or more software modules. In addition to executing an operating system, the processor may be configured to execute one or more software applications, including a web browser, a telephone application, an email program, or any other software application.

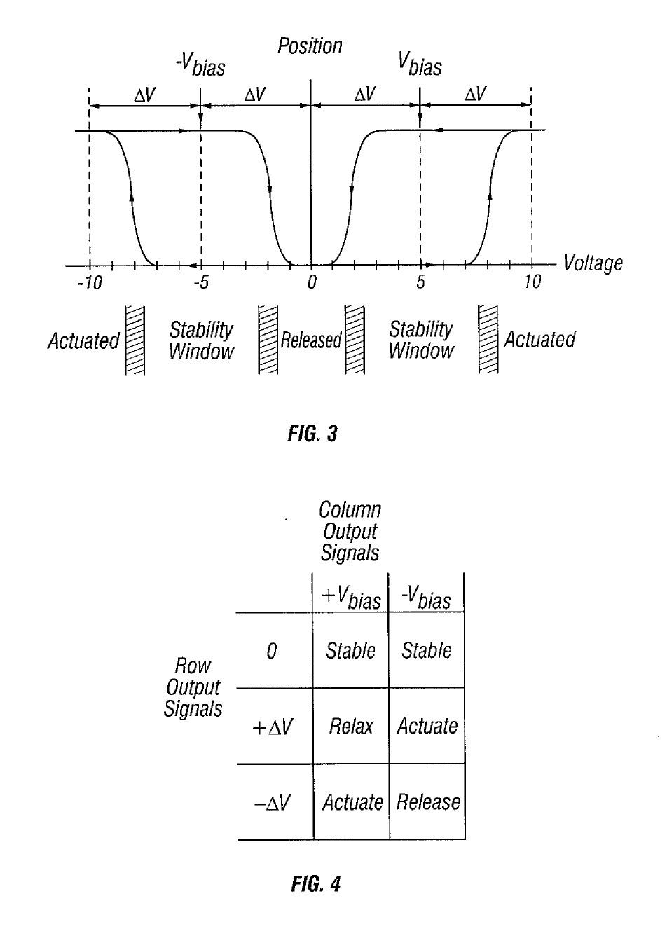

In one embodiment, the processor 21 is also configured to communicate with an array driver 22. In one embodiment, the array driver 22 includes a row driver circuit 24 and a column driver circuit 26 that provide signals to a panel or display array (display) 30. The cross section of the array illustrated in FIG. 1 is shown by the lines 1-1 in FIG. 2. For MEMS interferometric modulators, the row/column actuation protocol may take advantage of a hysteresis property of these devices illustrated in FIG. 3. It may require, for example, a 10 volt potential difference to cause a movable layer to deform from the relaxed state to the actuated state. However, when the voltage is reduced from that value, the movable layer maintains its state as the voltage drops back below 10 volts. In the exemplary embodiment of FIG. 3, the movable layer does not relax completely until the voltage drops below 2 volts. There is thus a range of voltage, about 3 to 7 V in the example illustrated in FIG. 3, where there exists a window of applied voltage within which the device is stable in either the relaxed or actuated state. This is referred to herein as the “hysteresis window” or “stability window.” For a display array having the hysteresis characteristics of FIG. 3, the row/column actuation protocol can be designed such that during row strobing, pixels in the strobed row that are to be actuated are exposed to a voltage difference of about 10 volts, and pixels that are to be relaxed are exposed to a voltage difference of close to zero volts. After the strobe, the pixels are exposed to a steady state voltage difference of about 5 volts such that they remain in whatever state the row strobe put them in. After being written, each pixel sees a potential difference within the “stability window” of 3-7 volts in this example. This feature makes the pixel design illustrated in FIG. 1 stable under the same applied voltage conditions in either an actuated or relaxed pre-existing state. Since each pixel of the interferometric modulator, whether in the actuated or relaxed state, is essentially a capacitor formed by the fixed and moving reflective layers, this stable state can be held at a voltage within the hysteresis window with almost no power dissipation. Essentially no current flows into the pixel if the applied potential is fixed.

In typical applications, a display frame may be created by asserting the set of column electrodes in accordance with the desired set of actuated pixels in the first row. A row pulse is then applied to the row 1 electrode, actuating the pixels corresponding to the asserted column lines. The asserted set of column electrodes is then changed to correspond to the desired set of actuated pixels in the second row. A pulse is then applied to the row 2 electrode, actuating the appropriate pixels in row 2 in accordance with the asserted column electrodes. The row 1 pixels are unaffected by the row 2 pulse, and remain in the state they were set to during the row 1 pulse. This may be repeated for the entire series of rows in a sequential fashion to produce the frame. Generally, the frames are refreshed and/or updated with new display data by continually repeating this process at some desired number of frames per second. A wide variety of protocols for driving row and column electrodes of pixel arrays to produce display frames are also well known and may be used in conjunction with the present invention.

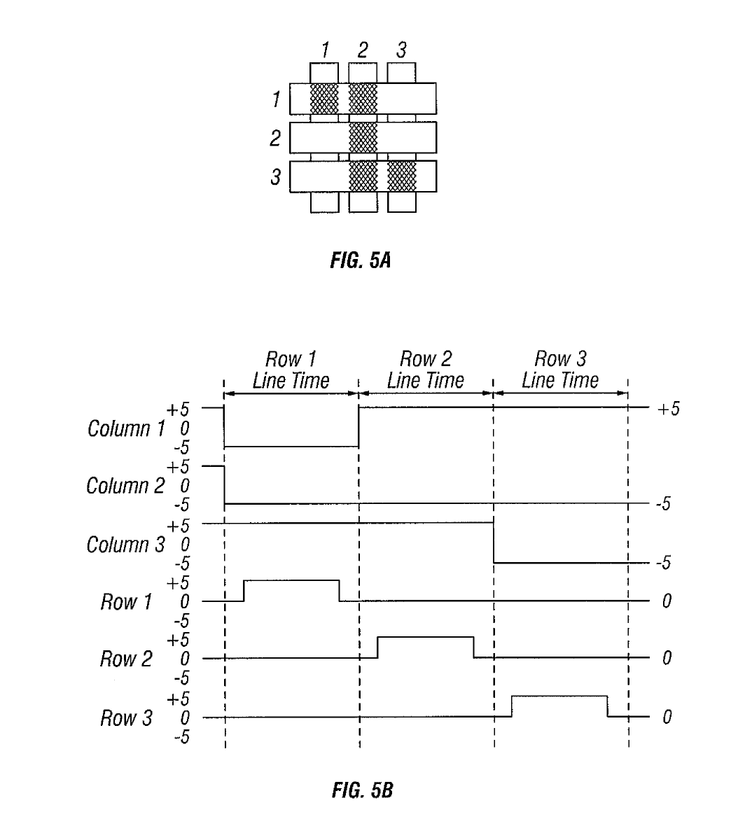

FIGS. 4 and 5 illustrate one possible actuation protocol for creating a display frame on the 3×3 array of FIG. 2. FIG. 4 illustrates a possible set of column and row voltage levels that may be used for pixels exhibiting the hysteresis curves of FIG. 3. In the FIG. 4 embodiment, actuating a pixel involves setting the appropriate column to −V_{bias}, and the appropriate row to +ΔV, which may correspond to −5 volts and +5 volts respectively. Relaxing the pixel is accomplished by setting the appropriate column to +V_{bias}, and the appropriate row to the same +ΔV, producing a zero volt potential difference across the pixel. In those rows where the row voltage is held at zero volts, the pixels are stable in whatever state they were originally in, regardless of whether the column is at +V_{bias}, or −V_{bias}. As is also illustrated in FIG. 4, it will be appreciated that voltages of opposite polarity than those described above can be used, e.g., actuating a pixel can involve setting the appropriate column to +V_{bias}, and the appropriate row to −ΔV. In this embodiment, releasing the pixel is accomplished by setting the appropriate column to −V_{bias}, and the appropriate row to the same −ΔV, producing a zero volt potential difference across the pixel.

FIG. 5B is a timing diagram showing a series of row and column signals applied to the 3×3 array of FIG. 2 which will result in the display arrangement illustrated in FIG. 5A, where actuated pixels are non-reflective. Prior to writing the frame illustrated in FIG. 5A, the pixels can be in any state, and in this example, all the rows are at 0 volts, and all the columns are at +5 volts. With these applied voltages, all pixels are stable in their existing actuated or relaxed states.

In the FIG. 5A frame, pixels (1,1), (1,2), (2,2), (3,2) and (3,3) are actuated. To accomplish this, during a “line time” for row 1, columns 1 and 2 are set to −5 volts, and column 3 is set to +5 volts. This does not change the state of any pixels, because all the pixels remain in the 3-7 volt stability window. Row 1 is then strobed with a pulse that goes from 0, up to 5 volts, and back to zero. This actuates the (1,1) and (1,2) pixels and relaxes the (1,3) pixel. No other pixels in the array are affected. To set row 2 as desired, column 2 is set to −5 volts, and columns 1 and 3 are set to +5 volts. The same strobe applied to row 2 will then actuate pixel (2,2) and relax pixels (2,1) and (2,3). Again, no other pixels of the array are affected. Row 3 is similarly set by setting columns 2 and 3 to −5 volts, and column 1 to +5 volts. The row 3 strobe sets the row 3 pixels as shown in FIG. 5A. After writing the frame, the row potentials are zero, and the column potentials can remain at either +5 or −5 volts, and the display is then stable in the arrangement of FIG. 5A. It will be appreciated that the same procedure can be employed for arrays of dozens or hundreds of rows and columns. It will also be appreciated that the timing, sequence, and levels of voltages used to perform row and column actuation can be varied widely within the general principles outlined above, and the above example is exemplary only, and any actuation voltage method can be used with the systems and methods described herein.

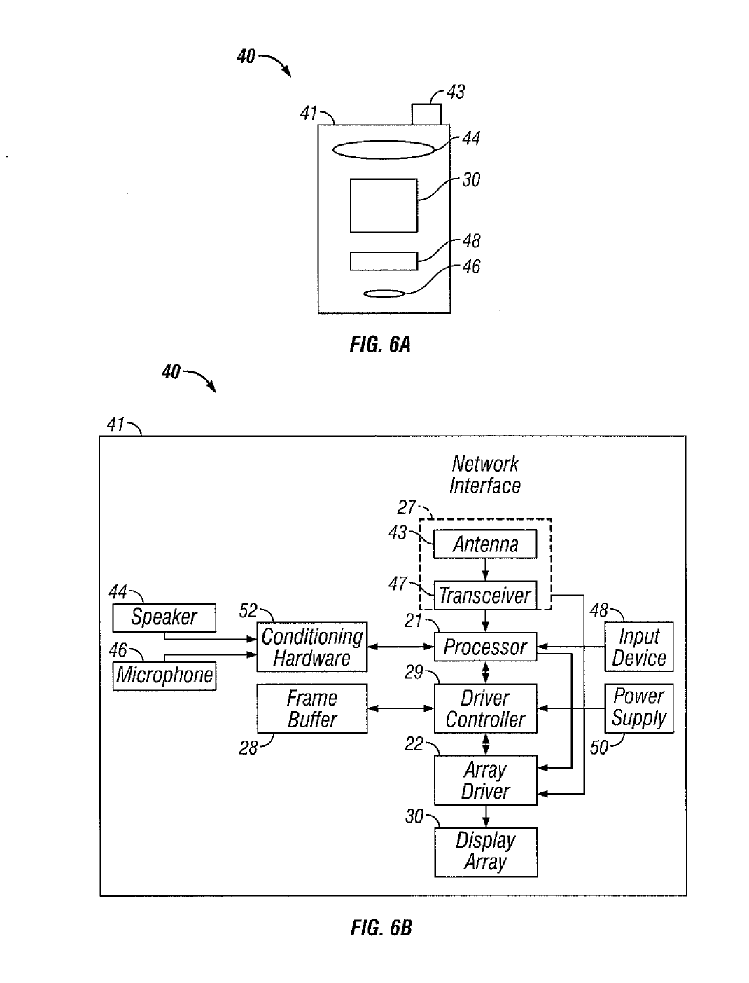

FIGS. 6A and 6B are system block diagrams illustrating an embodiment of a display device 40. The display device 40 can be, for example, a cellular or mobile telephone. However, the same components of display device 40 or slight variations thereof are also illustrative of various types of display devices such as televisions and portable media players.

The display device 40 includes a housing 41, a display 30, an antenna 43, a speaker 45, an input device 48, and a microphone 46. The housing 41 is generally formed from any of a variety of manufacturing processes as are well known to those of skill in the art, including injection molding, and vacuum forming. In addition, the housing 41 may be made from any of a variety of materials, including but not limited to plastic, metal, glass, rubber, and ceramic, or a combination thereof. In one embodiment the housing 41 includes removable portions (not shown) that may be interchanged with other removable portions of different color, or containing different logos, pictures, or symbols.

The display 30 of exemplary display device 40 may be any of a variety of displays, including a bi-stable display, as described herein. In other embodiments, the display 30 includes a flat-panel display, such as plasma, EL, OLED, STN LCD, or TFT LCD as described above, or a non-flat-panel display, such as a CRT or other tube device, as is well known to those of skill in the art. However, for purposes of describing the present embodiment, the display 30 includes an interferometric modulator display, as described herein.

The components of one embodiment of exemplary display device 40 are schematically illustrated in FIG. 6B. The illustrated exemplary display device 40 includes a housing 41 and can include additional components at least partially enclosed therein. For example, in one embodiment, the exemplary display device 40 includes a network interface 27 that includes an antenna 43 which is coupled to a transceiver 47. The transceiver 47 is connected to the processor 21, which is connected to conditioning hardware 52. The conditioning hardware 52 may be configured to condition a signal (e.g. filter a signal). The conditioning hardware 52 is connected to a speaker 45 and a microphone 46. The processor 21 is also connected to an input device 48 and a driver controller 29. The driver controller 29 is coupled to a frame buffer 28 and to the array driver 22, which in turn is coupled to a display array 30. A power supply 50 provides power to all components as required by the particular exemplary display device 40 design.

The network interface 27 includes the antenna 43 and the transceiver 47 so that the exemplary display device 40 can communicate with one ore more devices over a network. In one embodiment the network interface 27 may also have some processing capabilities to relieve requirements of the processor 21. The antenna 43 is any antenna known to those of skill in the art for transmitting and receiving signals. In one embodiment, the antenna transmits and receives RF signals according to the IEEE 802.11 standard, including IEEE 802.11(a), (b), or (g). In another embodiment, the antenna transmits and receives RF signals according to the BLUETOOTH standard. In the case of a cellular telephone, the antenna is designed to receive CDMA, GSM, AMPS or other known signals that are used to communicate within a wireless cell phone network. The transceiver 47 pre-processes the signals received from the antenna 43 so that they may be received by and further manipulated by the processor 21. The transceiver 47 also processes signals received from the processor 21 so that they may be transmitted from the exemplary display device 40 via the antenna 43.

In an alternative embodiment, the transceiver 47 can be replaced by a receiver. In yet another alternative embodiment, network interface 27 can be replaced by an image source, which can store or generate image data to be sent to the processor 21. For example, the image source can be a digital video disc (DVD) or a hard-disc drive that contains image data, or a software module that generates image data.

Processor 21 generally controls the overall operation of the exemplary display device 40. The processor 21 receives data, such as compressed image data from the network interface 27 or an image source, and processes the data into raw image data or into a format that is readily processed into raw image data. The processor 21 then sends the processed data to the driver controller 29 or to frame buffer 28 for storage. Raw data typically refers to the information that identifies the image characteristics at each location within an image. For example, such image characteristics can include color, saturation, and gray-scale level.

In one embodiment, the processor 21 includes a microcontroller, CPU, or logic unit to control operation of the exemplary display device 40. Conditioning hardware 52 generally includes amplifiers and filters for transmitting signals to the speaker 45, and for receiving signals from the microphone 46. Conditioning hardware 52 may be discrete components within the exemplary display device 40, or may be incorporated within the processor 21 or other components.

The driver controller 29 takes the raw image data generated by the processor 21 either directly from the processor 21 or from the frame buffer 28 and reformats the raw image data appropriately for high speed transmission to the array driver 22. Specifically, the driver controller 29 reformats the raw image data into a data flow having a raster-like format, such that it has a time order suitable for scanning across the display array 30. Then the driver controller 29 sends the formatted information to the array driver 22. Although a driver controller 29, such as a LCD controller, is often associated with the system processor 21 as a stand-alone Integrated Circuit (IC), such controllers may be implemented in many ways. They may be embedded in the processor 21 as hardware, embedded in the processor 21 as software, or fully integrated in hardware with the array driver 22.

Typically, the array driver 22 receives the formatted information from the driver controller 29 and reformats the video data into a parallel set of waveforms that are applied many times per second to the hundreds and sometimes thousands of leads coming from the display's x-y matrix of pixels.

In one embodiment, the driver controller 29, array driver 22, and display array 30 are appropriate for any of the types of displays described herein. For example, in one embodiment, driver controller 29 is a conventional display controller or a bi-stable display controller (e.g., an interferometric modulator controller). In another embodiment, array driver 22 is a conventional driver or a bi-stable display driver (e.g., an interferometric modulator display). In one embodiment, a driver controller 29 is integrated with the array driver 22. Such an embodiment is common in highly integrated systems such as cellular phones, watches, and other small area displays. In yet another embodiment, display array 30 is a typical display array or a bi-stable display array (e.g., a display including an array of interferometric modulators).

The input device 48 allows a user to control the operation of the exemplary display device 40. In one embodiment, input device 48 includes a keypad, such as a QWERTY keyboard or a telephone keypad, a button, a switch, a touch-sensitive screen, a pressure- or heat-sensitive membrane. In one embodiment, the microphone 46 is an input device for the exemplary display device 40. When the microphone 46 is used to input data to the device, voice commands may be provided by a user for controlling operations of the exemplary display device 40.

Power supply 50 can include a variety of energy storage devices as are well known in the art. For example, in one embodiment, power supply 50 is a rechargeable battery, such as a nickel-cadmium battery or a lithium ion battery. In another embodiment, power supply 50 is a renewable energy source, a capacitor, or a solar cell, including a plastic solar cell, and solar-cell paint. In another embodiment, power supply 50 is configured to receive power from a wall outlet.

In some implementations control programmability resides, as described above, in a driver controller which can be located in several places in the electronic display system. In some cases control programmability resides in the array driver 22. Those of skill in the art will recognize that the above-described optimization may be implemented in any number of hardware and/or software components and in various configurations.

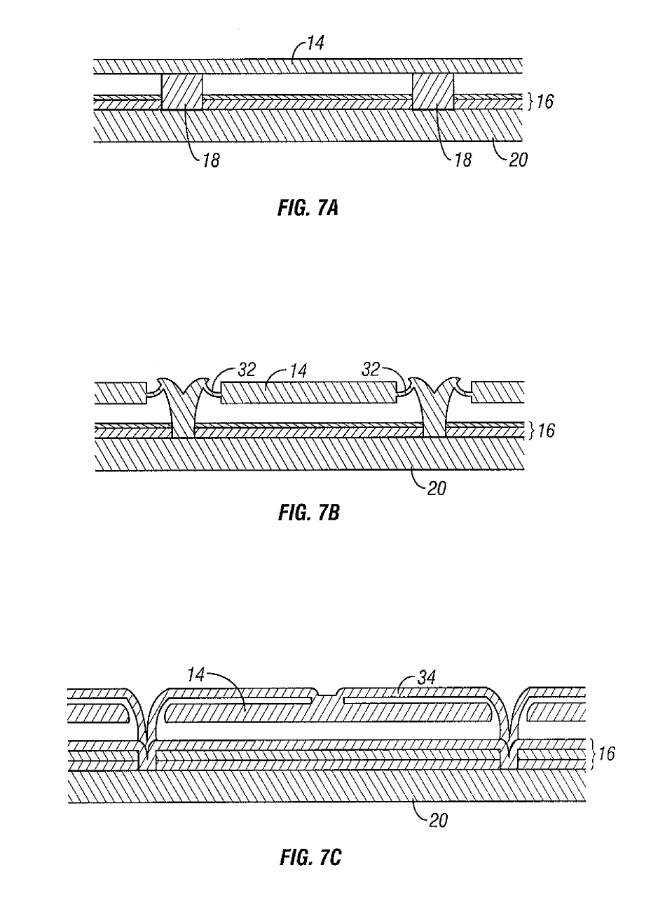

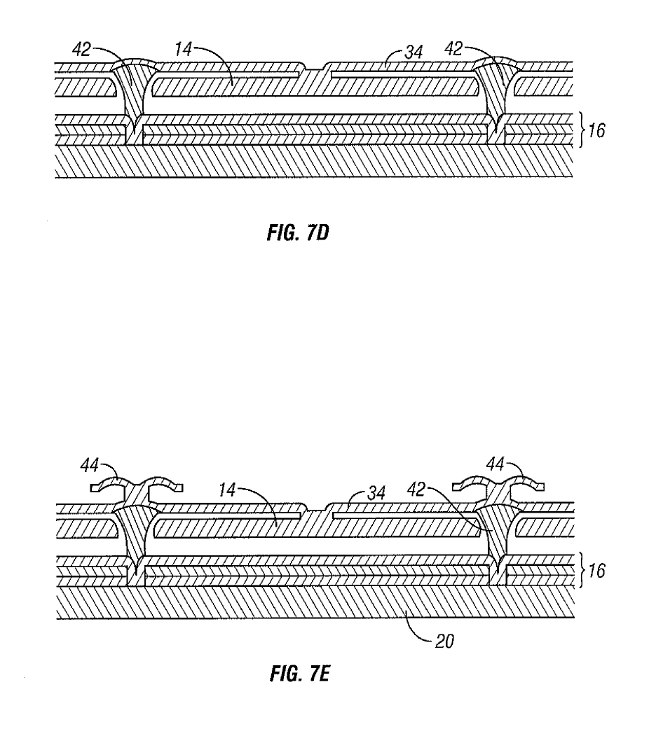

The details of the structure of interferometric modulators that operate in accordance with the principles set forth above may vary widely. For example, FIGS. 7A-7E illustrate five different embodiments of the movable reflective layer 14 and its supporting structures. FIG. 7A is a cross section of the embodiment of FIG. 1, where a strip of metal material 14 is deposited on orthogonally extending supports 18. In FIG. 7B, the moveable reflective layer 14 is attached to supports at the corners only, on tethers 32. In FIG. 7C, the moveable reflective layer 14 is suspended from a deformable layer 34, which may comprise a flexible metal. The deformable layer 34 connects, directly or indirectly, to the substrate 20 around the perimeter of the deformable layer 34. These connections are herein referred to as support posts. The embodiment illustrated in FIG. 7D has support post plugs 42 upon which the deformable layer 34 rests. The movable reflective layer 14 remains suspended over the cavity, as in FIGS. 7A-7C, but the deformable layer 34 does not form the support posts by filling holes between the deformable layer 34 and the optical stack 16. Rather, the support posts are formed of a planarization material, which is used to form support post plugs 42. The embodiment illustrated in FIG. 7E is based on the embodiment shown in FIG. 7D, but may also be adapted to work with any of the embodiments illustrated in FIGS. 7A-7C as well as additional embodiments not shown. In the embodiment shown in FIG. 7E, an extra layer of metal or other conductive material has been used to form a bus structure 44. This allows signal routing along the back of the interferometric modulators, eliminating a number of electrodes that may otherwise have had to be formed on the substrate 20.

In embodiments such as those shown in FIG. 7, the interferometric modulators function as direct-view devices, in which images are viewed from the front side of the transparent substrate 20, the side opposite to that upon which the modulator is arranged. In these embodiments, the reflective layer 14 optically shields some portions of the interferometric modulator on the side of the reflective layer opposite the substrate 20, including the deformable layer 34 and the bus structure 44. This allows the shielded areas to be configured and operated upon without negatively affecting the image quality. This separable modulator architecture allows the structural design and materials used for the electromechanical aspects and the optical aspects of the modulator to be selected and to function independently of each other. Moreover, the embodiments shown in FIGS. 7C-7E have additional benefits deriving from the decoupling of the optical properties of the reflective layer 14 from its mechanical properties, which are carried out by the deformable layer 34. This allows the structural design and materials used for the reflective layer 14 to be optimized with respect to the optical properties, and the structural design and materials used for the deformable layer 34 to be optimized with respect to desired mechanical properties.

The diagram of movable mirror position versus applied voltage shown in FIG. 3 is for an idealized interferometric modulator having an offset voltage of zero. In this context, the term “offset voltage” refers to the voltage potential present across two layers of the interferometric modulator separated by a gap when an external voltage is not being applied. The offset voltage may be determined by averaging the positive and negative actuation voltages of an interferometric modulator. For an idealized interferometric modulator having an offset voltage of zero, actuation and relaxation of a pixel may be accomplished in a symmetrical fashion. For example, as described above for the embodiment of FIG. 4, actuating a pixel involves setting the appropriate column to −V_{bias}, and the appropriate row to +ΔV, which may correspond to −5 volts and +5 volts respectively. Relaxing the pixel is accomplished by setting the appropriate column to +V_{bias}, and the appropriate row to the same +ΔV, producing a zero volt potential difference across the pixel.

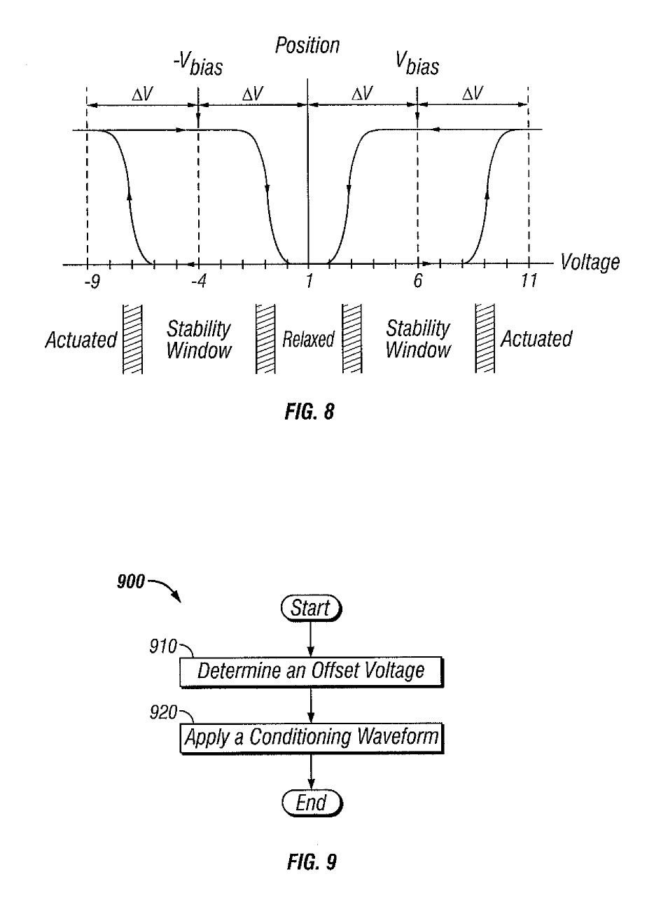

Interferometric modulators may be depicted in an idealized fashion as having an offset voltage of zero, but in practice it has been discovered that existing fabrication techniques have not been adequate to reliably manufacture interferometric modulators having an offset voltage of zero. Instead, it has been discovered that interferometric modulators fabricated by existing manufacturing techniques have significant non-zero offset voltages. For example, FIG. 8 shows a diagram of movable mirror position versus applied voltage for an interferometric modulator having an offset voltage of 1.0 volts. It will be appreciated that an actuation protocol such as that illustrated in FIGS. 4 and 5 would be significantly more complicated for an interferometric modulator having a non-zero offset voltage, e.g., for an interferometric modulator having an offset voltage of 1.0 volts as illustrated in FIG. 8. An interferometric modulator having a significant non-zero offset voltage may require higher drive voltages and thus may have undesirably higher power consumption. For example, it is frequently desirable to consider and compensate for the non-zero offset voltage when selecting the operational voltages used to control the moveable reflective layer 14, resulting in significantly more complicated drive schemes.

This invention is not bound by theory of operation, but it is believed that a fixed electrical charge may be associated with one or both of the layers 14, 16 for interferometric modulators fabricated by existing fabrication techniques, and that this fixed electrical charge results in a non-zero offset voltage. For example, charged species may be trapped on or within one or both of the layers 14, 16 during fabrication and/or subsequent processing, producing a fixed electrical charge that is manifested as a non-zero offset voltage in the resulting interferometric modulator 12 and/or the array 30. The non-zero offset voltage may also arise in other ways.

FIG. 9 is a flowchart illustrating a method of conditioning a microelectromechanical device. The process 900 begins, at block 910, by determining a non-zero offset voltage for a microelectromechanical (MEMS) device, such as the interferometric modulators shown in FIG. 7A-7E. Determining the offset voltage may be done in a number of ways. For example, in one embodiment, a positive actuation voltage, the positive voltage at which the interferometric modulator actuates, and a negative actuation voltage, the negative voltage at which the interferometric modulator actuates, are determined. These two voltages are averaged to give the offset voltage. The offset voltage of a MEMS device may also be found through modeling, simulation, or measurement of a similar device. Thus, in one embodiment, a first interferometric modulator is put through a first manufacturing and conditioning procedure. After this process, the offset voltage of the interferometric modulator is measured. A second interferometric is put through a second manufacturing and conditioning procedure, different from the first procedure, in order to reduce the resulting offset voltage of the second interferometric modulator in comparison to the offset voltage of the first interferometric modulator.

In block 920, a conditioning waveform is applied to the MEMS device that reduces the resulting offset voltage in comparison to other conditioning waveforms. In one embodiment, performance of an interferometric modulator display after manufacture may be improved by preconditioning the display. The preconditioning may be accomplished by applying a voltage to the display sufficient to actuate interferometric modulator elements in the display. Immediately after manufacture, the voltages at which interferometric modulators actuate may vary until a steady state behavior is reached. Thus, preconditioning may stress the movable interferometric modulator elements so that a stable or near stable response is achieved upon actuation. Furthermore, such preconditioning may remove transitory shorts between conductive leads by vaporizing conductive debris. In some embodiments, preconditioning may reveal defects not observed prior to preconditioning.

In one embodiment, the preconditioning voltage waveform is applied to substantially all elements in an interferometric modulator display simultaneously. In such a manner, each element may be stressed and conditioned identically so that the display response of each element is similar, reducing the observance of ghosting effects.

In one embodiment, a voltage waveform is applied to the display having an amplitude sufficient to actuate the interferometric modulators. The voltage may be applied to all interferometric modulators simultaneously or to a subset of the interferometric modulators. In typical conditioning processes, the voltage waveform is symmetric about some constant value to ensure that a net zero charge is supplied to the display elements. For example, a voltage waveform symmetric about 0 V or the determined offset voltage of the device may be applied to ensure no build up of charge in the display elements. However, when an offset voltage exists, it may be beneficial to select a different offset voltage, a conditioning offset voltage which is substantially different than the offset voltage of the device to reduce the charge already present and to reduce the resulting offset voltage of the device. In some embodiments, the conditioning offset voltage is of an opposite sign than the offset voltage of the device. In other embodiments, the conditioning offset voltage and the determined offset voltage of the device differ by 0.1 V or greater, 0.5 V or greater, or 1.0 V or greater.

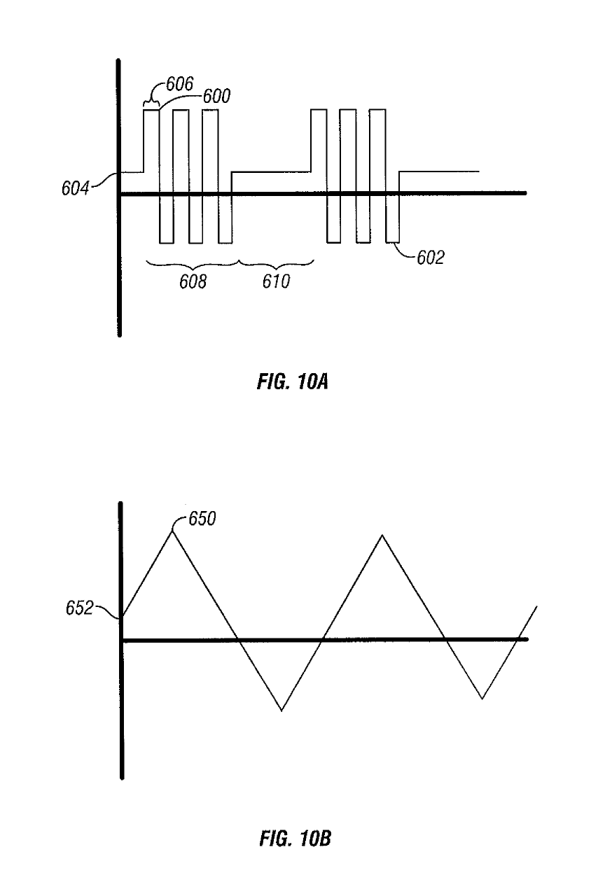

In one embodiment, the voltage waveform includes pulsing of an alternating square waveform. FIG. 10A illustrates one such possible voltage waveform. A series of square waves having amplitudes 600 sufficient to actuate the interferometric modulators may be applied. Thus, when the voltage is at the positive 600 or negative 602 amplitude values, the interferometric modulators are actuated. When the voltage is at the conditioning offset voltage 604, the interferometric modulators are in a non-actuated state. Each square waveform may have width 606 (e.g., 5 ms) before the polarity of the applied voltage is reversed. A series of such alternating square waveforms may have width 608 (e.g., 0.5 s). After applying this sequence, the voltage may be held at the conditioning offset potential 604 for time 610 (e.g., 0.5 s). Thus, the result of the waveform in FIG. 10A is that interferometric modulators will cycle through the sequence of an actuated state for time 608 followed by a non-actuated state for time 610. By making the waveform symmetric about the conditioning offset voltage 604 and quickly varying the amplitude between positive and negative polarities when driving the interferometric modulators in an actuated state, the resulting offset voltage of the device is reduced proportionally to the difference between the conditioning offset voltage and the determined offset voltage of the device. Those of skill in the art will recognize many variations of this waveform. For example, time periods 606, 608, and 610 may be varied to obtain different frequency of actuation pulsing (e.g., by varying times 608 and/or 610) and polarity pulsing (e.g., by varying time 606). In various embodiments, the actuation frequency may be at least about 0.1 Hz, 0.5 Hz, 1 Hz, 10 Hz, 50 Hz, 100 Hz, 500 Hz, or 1 kHz. In various embodiments, the polarity change frequency may be at least about 100 Hz, 1 kHz, 5 kHz, 10 kHz, 50 kHz, 100 k(Hz, 500 kHz, and 1 MHz. Furthermore, in some embodiments, a single actuation waveform having alternating polarity is applied (e.g., only period 608).

In another embodiment, the voltage waveform includes a triangular waveform. FIG. 10B illustrates one such possible waveform. The amplitudes 650 of the triangular waveform are high enough such that the interferometric modulators actuate before the amplitudes are reached. In one embodiment, amplitudes that are about 10% higher than the required actuation voltage are used. The interferometric modulators will de-actuate before the voltage reaches the conditioning offset voltage 652 about which the waveform is centered. In various embodiments, the frequency of the triangle waveform may be at least about 0.1 Hz, 0.5 Hz, 1 Hz, 10 Hz, 50 Hz, 100 Hz, 500 Hz, or 1 kHz.

Those of skill in the art will recognize many possible actuation voltage waveforms that may be used to precondition interferometric modulators. Thus, the disclosure is not limited to only square and triangular waveforms having the characteristics described above.

In some embodiments, different waveforms are combined in series to create a more complex waveform string. For example, the triangle and square waveforms described above may be combined in series. In one embodiment, the triangle waveform is applied for a first time period (e.g., about 1 minute) followed by multiple sequences of square waveforms (e.g., each about 1 minute with increasing amplitudes) followed by a second triangle waveform. This sequence may be repeated any number of times or varied to produce any number of waveform combinations. Those of skill in the art will recognize many other voltage waveforms and combinations of waveforms that may be applied to result in conditioning of the interferometric modulator elements in a display.

In various embodiments, variations in preconditioning voltage waveforms include varying the length of time a particular waveform is applied, varying the frequency of the waveform, and varying the amplitude of the waveform.

Although the conditioning waveform has thus far been described with respect to embodiments which are periodic and symmetric about a fixed conditioning offset voltage, other conditioning waveforms may be applied. For example, non-periodic and non-symmetric waveforms with an average of a conditioning offset voltage may be applied, including pseudorandom waveforms centered about the conditioning offset voltage. The average of the waveform may be determined in a number of ways known to those skilled in the art, including averaging the waveform over the entire conditioning process, or other portions of the process. For example, the average may be calculated as a time-varying average calculated every hour of the conditioning process, or using another suitable time period.

In some embodiments, the average of the waveform changes throughout the conditioning process. For example, in one embodiment, the conditioning offset voltage begins at a high value to bias the interferometric modulator to have a resulting offset voltage of zero, but lowers the value towards zeros throughout the conditioning process. The conditioning offset voltage may further be adaptive and responsive to a measured offset voltage offset of the device. For example, the conditioning offset voltage may initially be set to a first value dependent on a measured voltage offset of the device. As the voltage offset of the device changes throughout the conditioning process, the conditioning offset voltage may be dynamically adjusted (either increasing or decreasing) to compensate for the changed offset voltage of the device.

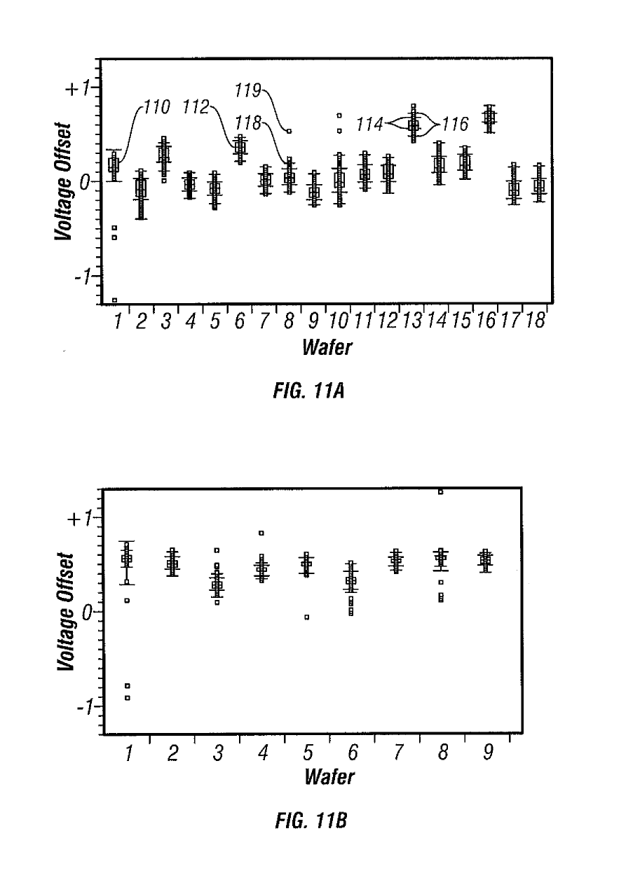

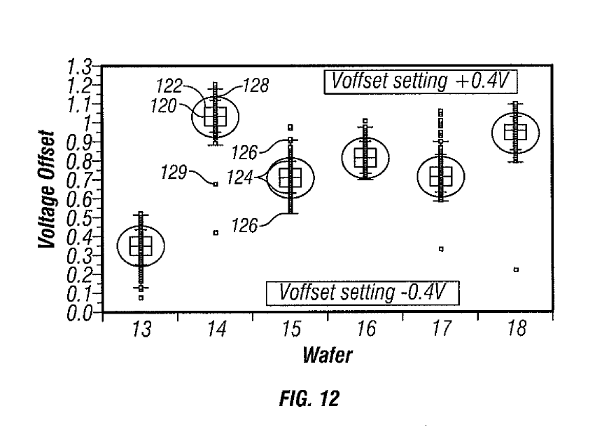

Embodiments of the invention which have been tested are described below with reference to FIGS. 11 and 12 and further reference to obtained empirical data. In particular, FIG. 11A is a diagram representing a plot of the offset voltage of a number of devices before a conditioning process has been performed, and FIG. 11B is a plot of the offset voltage of a number of devices after a conditioning process has been performed. The conditioning process in this example uses a conditioning offset voltage value of zero as a control measurement to compare between the existing conditioning methods and the improved conditioning methods described herein. In particular, one may note from FIG. 11A that the offset voltage of eighteen wafers has been measured as centered around a zero offset voltage before the conditioning process is performed.

Each wafer comprises 144 devices, and FIGS. 11A and 11B represents a box plot in which the offset voltage of each device for each wafer is marked by a square 119. FIGS. 11A and 11B are diagrams representing box plots of the data, and although an attempt was made to ensure accuracy of the diagrams, the resolution available precludes showing precise values for each of the 144 devices of each wafer, and the squares 119 overlap substantially to create shaded regions 118 of squares. Nevertheless, FIGS. 11A and 11B constructively demonstrate that the average offset value of a wafer generally increases upon application of a conditioning waveform with a zero conditioning offset voltage.

The median 110 for each wafer is shown surrounded by a box 112 presenting the values between which the middle 50 percent of data fall, the 25^{th} and 75^{th} percentile or lower and upper quartile. The difference between these percentiles is the interquartile range. Each box has two sets of lines 114, 116, sometimes called whiskers, on either side of the box to determine the nature and number of outliers. The first set of whiskers 114 comprises two lines, one on each the box marking the value of outermost data point that falls within the following distances: the upper quartile plus one and a half times the interquartile range and the lower quartile minus one and a half times the interquartile range. The second set of whiskers 116 comprises two lines, one of each side of the box marking the value of outermost data point that falls within the following distances: the upper quartile plus three times the interquartile range and the lower quartile minus three times the interquartile range.

The median of the offset voltage of the 144 devices of a wafer is referred to as the voltage offset of the wafer. Other definitions for the offset voltage of a plurality of devices may be used in embodiments of the invention, such as the average value. As seen in FIG. 11A, certain wafers exhibit positive offset voltages, whereas other wafers exhibit negative offset voltages. A conditioning process with a zero conditioning offset voltage was performed on wafers 1-9. This conditioning process results, as shown in FIG. 11B, in a positive offset voltage between 0.5V and 1.0V. In particular, one may note that the offset voltage of each device is increased by the application of the conditioning waveform with a zero conditioning offset voltage. Although the wafers shown in FIG. 11A had offset voltages centered about zero volts, other manufacturing methods may introduce an offset voltage prior to the application of a conditioning waveform.

FIG. 12 is a diagram representing a box plot of the offset voltage of a number of devices after a conditioning process has been performed with conditioning waveforms having different average values in which the offset voltage of each device for each wafer is marked by a square 129. As with FIGS. 11A and 11B, FIG. 12 is a diagram representing a box plot of the data, and although an attempt was made to ensure accuracy of the diagrams, the resolution available precludes showing precise values for each of the 144 devices of each wafer, and the squares 129 overlap substantially to create shaded regions 128 of squares. Nevertheless, FIG. 12 constructively demonstrates that the average offset value of a wafer conditioned by a waveform with a positive conditioning offset voltage is larger than the average offset voltage of a wafer conditioned by a waveform with a negative conditioning offset voltage.

FIG. 12 adheres to the conventions used in FIGS. 11A and 11B, in that the median 120 for each wafer is shown surrounded by a box 122 presenting the values between which the middle 50 percent of data fall, the 25^{th} and 75^{th} percentile or lower and upper quartile. The difference between these percentiles is the interquartile range. Each box has two sets of lines 124, 126, sometimes called whiskers, on either side of the box to determine the nature and number of outliers. The first set of whiskers 124 comprises two lines, one on each the box marking the value of outermost data point that falls within the following distances: the upper quartile plus one and a half times the interquartile range and the lower quartile minus one and a half times the interquartile range. The second set of whiskers 126 comprises two lines, one of each side of the box marking the value of outermost data point that falls within the following distances: the upper quartile plus three times the interquartile range and the lower quartile minus three times the interquartile range.

Wafers 13, 15, and 17 were conditioned using a conditioning offset voltage of −0.4V, whereas wafers 14, 16, and 18 were conditioned using a condition offset voltage of +0.4V. Wafers 13, 15, and 17 each exhibit a lower offset voltage after the conditioning process compared to wafers 14, 16, and 18. From this data, it is concluded that application of a conditioning waveform with a lower conditioning offset voltage reduces the resultant offset voltage of the device when compared to resultant offset voltage of the device after application of a conditioning waveform with a higher conditioning offset voltage.

Conditioning waveforms of the form shown in FIG. 10A were applied to a number of different devices using a number of initial settings. A number of devices to which a conditioning waveform varying between −9.6V and 9.6V with a zero conditioning offset voltage yielded devices having an offset voltage between 1.0V and 1.6V. In comparison, a number of devices to which a conditioning waveform varying between −9.0V and 9.0V with a zero conditioning offset voltage yielded devices having an offset voltage between 1.2V and 1.7V. A number of devices to which a conditioning waveform varying between −9.38V and 8.62V, thus having a conditioning offset voltage of 0.38V yielded devices having an offset voltage between 0.8V and 1.3V. Finally, a number of devices to which a conditioning waveform varying between −10V and 8V, thus having a conditioning offset of −1V, yielded devices having an offset voltage between 0.0V and 0.7V. One may further speculate that a conditioning offset voltage of −2.0V may further reduce the resulting offset voltage of the devices to a range centered on zero volts, e.g. between −0.3V and 0.3V.

Although the invention has been described with reference to embodiments and examples, it should be understood that numerous and various modifications can be made without departing from the spirit of the invention. Accordingly, the invention is limited only by the following claims.

What is claimed is:

1. A method of conditioning a microclectromechanical device, the method comprising:
applying a conditioning signal to a microelectromechanical device having an offset voltage of a first sign, the conditioning signal having an average that is of a second sign which is opposite the first sign.

2. The method of claim 1, wherein the conditioning signal has an amplitude high enough to actuate the microelectromechanical device.

3. The method of claim 1, wherein the microelectromechanical device is an interferometric modulator.

4. The method of claim 3, wherein the interferometric modulator is part of a display comprising a plurality of interferometric modulators.

5. The method of claim 3, wherein the conditioning signal is applied prior to use of the display.

6. The method of claim 4, wherein the conditioning signal is applied to substantially all of the plurality of interferometric modulators in the display simultaneously.

7. The method of claim 1, wherein the conditioning signal includes an alternating square waveform.

8. The method of claim 1, wherein the conditioning signal includes a triangular waveform.

9. The method of claim 1, further comprising heating the microelectromechanical device at a temperature between 50° C. and 350° C.

10. The method of claim 1, wherein the conditioning signal is applied from between four hours and twelve hours.

11. A microelectromechanical device made by the process of claim 1.

12. The device of claim 11, wherein the device comprises an interferometric modulator.

13. A display device comprising the interferometric modulator of claim 12.

14. The display device of claim 13, further comprising;
a display;
a processor that is in electrical communication with the display, the processor being configured to process image data;
a memory device in electrical communication with the processor.

15. The display device of claim 14, further comprising:
a driver circuit configured to sent at least one signal to the display.

16. The display device of claim 15, father comprising:
a controller configured to send at least a portion of the image data to the driver circuit.

17. The display device of claim 14, further comprising:
an image source module configured to send the image data to the processor.

18. The display device of claim 17, wherein the image source module comprises at least one of a receiver, a transceiver, or a transmitter.

19. The display device of claim 14, further comprising:
an input device configured to receiver input data and to communicate the input data to the processor.

20. A method of conditioning a microelectromechanical device, the method comprising:
applying a conditioning signal to a microelectromechanical device having an offset voltage of a first value, the conditioning signal having an average of a second value, wherein the absolute difference between the first value and the second value is greater than 0.1 volts.
